(19) United States
(12) Patent Application Publication
(10) Pub. No.: US 2022/0019105 A1
(43) Pub. Date: Jan. 20, 2022

(54) BACKLIGHT MODULE AND DISPLAY DEVICE

(71) Applicant: WUHAN CHINA STAR OPTOELECTRONICS TECHNOLOGY CO., LTD., WUHAN, HUBEI (CN)

(72) Inventor: Hu LIU, Wuhan, Hubei (CN)

(21) Appl. No.: 17/042,138

(22) PCT Filed: Aug. 20, 2020
(86) PCT No.: PCT/CN2020/110243

§ 371 Date: Sep. 27, 2020

(30) Foreign Application Priority Data
Jul. 15, 2020 (CN) 2020106795686

(51) Int. Cl. G02F 1/1333; G02F 1/13357

(52) U.S. Cl. CPC G02F 1/133308; G02F 2202/28; G02F 1/133608

(57) ABSTRACT

A backlight module and a display device are disclosed, which include: a frame housing including a plurality of stress buffering sections corresponding to bending positions and a plurality of non-stress buffering sections adjacently connected to both ends of the stress buffering sections; a backlight element group disposed in an area surrounded by the frame housing; an adhesive disposed on a top of the frame housing corresponding to at least the non-stress buffering sections and surrounding the frame housing; and a buffer component disposed on the top of the frame housing corresponding to at least the stress buffering sections, wherein the buffer component and the adhesive are staggered from each other.

### FIELD OF INVENTION

The present disclosure relates to the field of display technologies, and more particularly, to a backlight module and a display device having the backlight module.

### BACKGROUND OF INVENTION

With rapid development of display technologies, display modules are developing toward under-display fingerprint identification, under-screen cameras, and 3D curved displays. In display modules, such as mobile phones, tablets, monitors, and laptops, display effect and product competitiveness can be effectively improved by introducing 3D side-curved displays.

However, display screens of side-curved mobile phones in current technology use organic light-emitting diode (OLED) screens. If the display screens use other types of display screens such as liquid crystal displays (LCDs), since backlight modules have greater stresses in bending positions, poor bonding is prone to occur, especially bonding between an adhesive and a display module, thereby causing a technical problem of loss of effectiveness.

Technical problem: an embodiment of the present disclosure provides a backlight module and display device, which can solve a technical problem of poor bonding between a backlight module and a display module due to greater stresses suffered by the backlight module in bending positions in current technology, thereby affecting display.

### SUMMARY OF INVENTION

In order to solve the above problem, an embodiment of the present disclosure provides a backlight module. The backlight module includes:

a frame housing including a plurality of stress buffering sections corresponding to bending positions and a plurality of non-stress buffering sections adjacently connected to both ends of the stress buffering sections;

a backlight element group disposed in an area surrounded by the frame housing;

an adhesive disposed on a top of the frame housing corresponding to at least the non-stress buffering sections and surrounding the frame housing; and

a buffer component disposed on the top of the frame housing corresponding to at least the stress buffering sections, wherein the buffer component and the adhesive are staggered from each other.

In an embodiment of the present disclosure, a side of the buffer component facing toward an interior of the frame housing is provided with protrusions, positions of the adhesive corresponding to the protrusions are provided with notches, and the protrusions are fitted with the notches.

In an embodiment of the present disclosure, a side of the buffer component facing away from an interior of the frame housing is provided with protrusions, positions of the adhesive corresponding to the protrusions are provided with notches, and the protrusions are fitted with the notches.

In an embodiment of the present disclosure, the buffer component is disposed in the stress buffering sections correspondingly.

In an embodiment of the present disclosure, the buffer component is disposed in the stress buffering sections correspondingly, and a part of the buffer component extends to the non-stress buffering sections.

In an embodiment of the present disclosure, the bending positions include first bending positions formed by bending two opposite sides of the frame housing toward a side facing away from the adhesive.

In an embodiment of the present disclosure, the frame housing includes a plurality of side walls, and the bending positions further include second bending positions formed by connecting two of the side walls adjacent to each other.

In an embodiment of the present disclosure, the buffer component includes a single-sided glue, a double-sided glue, or a foam glue material.

In an embodiment of the present disclosure, a thickness of the buffer component ranges from 0.02 mm to 1 mm.

According to the above objective of the present disclosure, a display device is provided. The display device includes a backlight module and a display module attached to the backlight module by an adhesive;

wherein the backlight module includes:

a frame housing including a plurality of stress buffering sections corresponding to bending positions and a plurality of non-stress buffering sections adjacently connected to both ends of the stress buffering sections;

a backlight element group disposed in an area surrounded by the frame housing;

the adhesive disposed on a top of the frame housing corresponding to at least the non-stress buffering sections and surrounding the frame housing; and

a buffer component disposed on the top of the frame housing corresponding to at least the stress buffering sections, wherein the buffer component and the adhesive are staggered from each other.

In an embodiment of the present disclosure, a side of the buffer component facing toward an interior of the frame housing is provided with protrusions, positions of the adhesive corresponding to the protrusions are provided with notches, and the protrusions are fitted with the notches.

In an embodiment of the present disclosure, a side of the buffer component facing away from an interior of the frame housing is provided with protrusions, positions of the adhesive corresponding to the protrusions are provided with notches, and the protrusions are fitted with the notches.

In an embodiment of the present disclosure, the buffer component is disposed in the stress buffering sections correspondingly.

In an embodiment of the present disclosure, the buffer component is disposed in the stress buffering sections correspondingly, and a part of the buffer component extends to the non-stress buffering sections.

In an embodiment of the present disclosure, the bending positions include first bending positions formed by bending two opposite sides of the frame housing toward a side facing away from the adhesive.

In an embodiment of the present disclosure, the frame housing includes a plurality of side walls, and the bending positions further include second bending positions formed by connecting two of the side walls adjacent to each other.

In an embodiment of the present disclosure, the buffer component includes a single-sided glue, a double-sided glue, or a foam glue material.

In an embodiment of the present disclosure, a thickness of the buffer component ranges from 0.02 mm to 1 mm.

Beneficial effect: by disposing the buffer component in the bending positions of the frame housing and allowing the buffer component and the adhesive to be disposed staggeredly, the present disclosure allows the backlight module to have buffer effect on stresses in the bending positions. Therefore, influences of bending stresses on the backlight module can be reduced during bonding, and the backlight module and the display module can have better mechanical and physical performances, thereby preventing poor bonding or loss of effectiveness from occurring and improving display effect and product yield.

### DESCRIPTION OF DRAWINGS

The following detailed description of specific embodiments of the present disclosure will make the technical solutions and other beneficial effects of the present disclosure obvious with reference to the accompanying drawings.

FIG. 1 is a partial schematic structural side view of a backlight module according to an embodiment of the present disclosure.

FIG. 2 is a schematic cross-sectional structural diagram of the backlight module according to an embodiment of the present disclosure.

FIG. 3 is a schematic planar structural diagram of a backlight module according to an embodiment of the present disclosure.

FIG. 4 is a schematic planar structural diagram of another backlight module according to an embodiment of the present disclosure.

### DETAILED DESCRIPTION OF PREFERRED EMBODIMENTS

The technical solutions in the embodiments of the present disclosure will be clearly and completely described below with reference to the drawings in the embodiments of the present disclosure. Obviously, the described embodiments are only a part of the embodiments of the present disclosure, but not all the embodiments. Based on the embodiments in the present disclosure, all other embodiments obtained by those skilled in the art without creative efforts are within the scope of the present disclosure.

In the description of the present disclosure, it should be understood that terms such as “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, “counter-clockwise”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance or implicitly indicating the number of technical features indicated. Thus, features limited by “first” and “second” are intended to indicate or imply including one or more than one these features. In the description of the present disclosure, “a plurality of” relates to two or more than two, unless otherwise specified.

In the description of the present disclosure, it should be noted that unless there are express rules and limitations, the terms such as “mount,” “connect,” and “bond” should be comprehended in broad sense. For example, it can mean a permanent connection, a detachable connection, or an integrated connection; it can mean a mechanical connection, an electrical connection, or can communicate with each other; it can mean a direct connection, an indirect connection by an intermediator, or an inner communication or an inter-reaction between two elements. A person skilled in the art should understand the specific meanings in the present disclosure according to specific situations.

In the description of the present disclosure, unless specified or limited otherwise, it should be noted that, a structure in which a first feature is “on” or “beneath” a second feature may include an embodiment in which the first feature directly contacts the second feature and may also include an embodiment in which an additional feature is formed between the first feature and the second feature so that the first feature does not directly contact the second feature. Furthermore, a first feature “on,” “above,” or “on top of” a second feature may include an embodiment in which the first feature is right “on,” “above,” or “on top of” the second feature and may also include an embodiment in which the first feature is not right “on,” “above,” or “on top of” the second feature, or just means that the first feature has a sea level elevation greater than the sea level elevation of the second feature. While first feature “beneath,” “below,” or “on bottom of” a second feature may include an embodiment in which the first feature is right “beneath,” “below,” or “on bottom of” the second feature and may also include an embodiment in which the first feature is not right “beneath,” “below,” or “on bottom of” the second feature, or just means that the first feature has a sea level elevation less than the sea level elevation of the second feature.

The following description provides many different embodiments or examples for implementing different structures of the present disclosure. In order to simplify the present disclosure, the components and settings of a specific example are described below. Of course, they are merely examples and are not intended to limit the present disclosure. In addition, the present disclosure may repeat reference numerals and/or reference letters in different examples, which are for the purpose of simplicity and clarity, and do not indicate the relationship between the various embodiments and/or arrangements discussed. In addition, the present disclosure provides examples of various specific processes and materials, but one of ordinary skill in the art will recognize the use of other processes and/or the use of other materials.

An embodiment of the present disclosure is directed to current backlight modules and display devices, and solves a technical problem of poor bonding between a backlight module and a display module due to greater stresses suffered by the backlight module in bending positions, thereby affecting display.

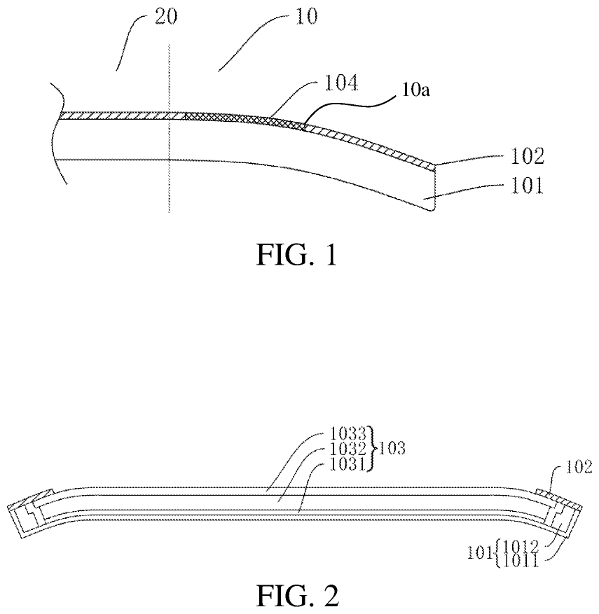

In order to solve the above technical problem, an embodiment of the present disclosure provides a backlight module. Referring to FIGS. 1 to 3, the backlight module includes: a frame housing 101 including a plurality of stress buffering sections 10 corresponding to bending positions and a plurality of non-stress buffering sections 20 adjacently connected to both ends of the stress buffering sections 10; a backlight element group 103 disposed in an area surrounded by the frame housing 101; an adhesive 102 disposed on a top of the frame housing 101 corresponding to at least the non-stress buffering sections 20 and surrounding the frame housing 101; and a buffer component 104 disposed on the top of the frame housing 101 corresponding to at least the stress buffering sections 10, wherein the buffer component 104 and the adhesive 102 are staggered from each other.

During application processes, backlight modules of current curved screens undergo greater bending stresses in bending positions, thereby causing the backlight modules to be prone to have problems such as light leakage and loss of effectiveness during bonding to an adhesive. By disposing the buffer component staggered with the adhesive in the bending positions, the backlight module provided by the embodiment of the present disclosure allows the backlight module to have buffer effect on the bending stresses in the bending positions. Therefore, the stresses suffered by the backlight module in the bending positions can be reduced, and the backlight module can have better mechanical and physical performances, thereby preventing the problems such as light leakage and loss of effectiveness from occurring during bonding and manufacturing and improving display effect and product yield.

Specifically, as shown in FIGS. 1 to 3, the backlight module includes the frame housing 101, the backlight element group 103 disposed in the area surrounded by the frame housing 101, the adhesive 102 disposed on the top of the frame housing 101, and the buffer component 104 disposed on the top of the frame housing 101 and staggered with the adhesive 102.

In the embodiment of the present disclosure, the backlight element group 103 includes a reflective sheet 1031, a light guide plate 1032, and an optical film set 1033 disposed in the frame housing 101 in sequence. The figure provided by the embodiment of the present disclosure only shows the above structural layers, but the backlight element group 103 also includes structures such as light sources of the backlight module. In addition, the frame housing 101 may include an iron frame 1011 and a plastic frame 1012 disposed inside the iron frame 1011. During application processes, the frame housing 101 may be only provided with the iron frame or may have a plastic-iron integrated structure, which is not limited here, and all the above structural layers can be set according to conventional processes, which is not repeated herein.

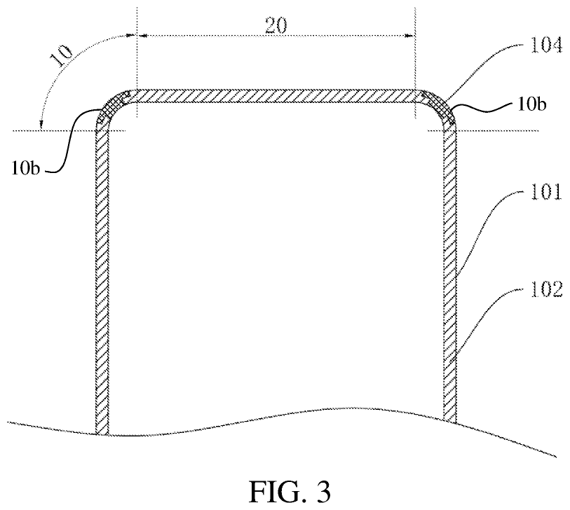

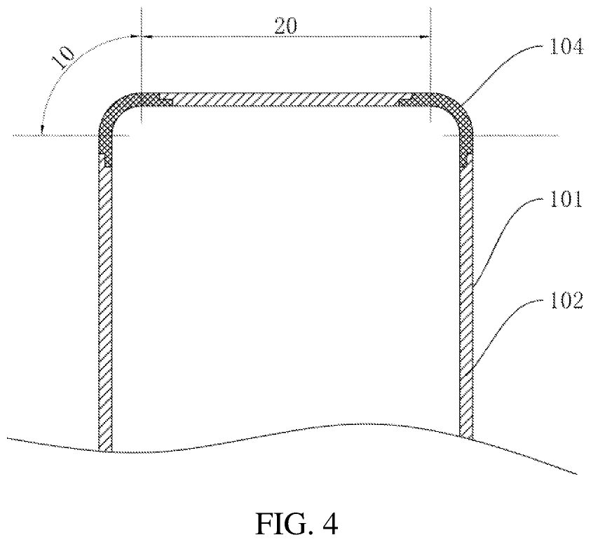

It should be noted that the backlight module includes the stress buffering sections 10 corresponding to the bending positions and the non-stress buffering sections 20 adjacently connected to both ends of the stress buffering sections 10. Further, in an embodiment of the present disclosure, the bending positions include first bending positions formed by bending two opposite sides of the frame housing 101 toward the side facing away from the adhesive 102. That is, as shown in FIG. 1 (which only shows one of the two sides), FIG. 1 shows one of the stress buffering sections 10 corresponding to one of the first bending positions. In addition, the frame housing 101 includes a plurality of side walls, and the bending positions further include second bending positions formed by connecting two of the side walls adjacent to each other. That is, as shown in FIG. 3, FIG. 3 shows the stress buffering sections 10 corresponding to the second bending positions.

The top of the frame housing 101 is provided with the adhesive 102 used for bonding and the buffer component 104 disposed staggeredly with the adhesive 102. Wherein, the adhesive 102 is disposed on the top of the frame housing 101 corresponding to at least the non-stress buffering sections 20 and surrounding the frame housing 101, and the buffer component 104 is disposed on the top of the frame housing 101 corresponding to at least the stress buffering sections 10. The buffer component 104 includes a single-sided glue, a double-sided glue, or a foam glue material, and a thickness of the buffer component 104 ranges from 0.02 mm to 1 mm. It should be noted that the adhesive 102 and the buffer component 104 are staggered from each other but in contact with each other and having no spacing, which can play a role in preventing the backlight module from having poor phenomena such as light leakage.

In an embodiment of the present disclosure, as shown in FIG. 3, the buffer component 104 may be disposed in the stress buffering sections 10 correspondingly, and a setting length thereof can be less than or equal to a length of the stress buffering sections 10. When the setting length of the buffer component 104 is equal to the length of the stress buffering sections 10, the adhesive 102 is correspondingly disposed in the non-stress buffering sections and in contact with the buffer component 104. When the setting length of the buffer component 104 is less than the length of the stress buffering sections 10, the adhesive 102 is correspondingly disposed in the non-stress buffering sections 20 and partially extends to the stress buffering sections 10 to be in contact with the buffer component 104.

In addition, in this embodiment, a side of the buffer component 104 facing toward an interior of the frame housing 101 is provided with protrusions, positions of the adhesive 102 corresponding to the protrusions are provided with notches, and the protrusions are fitted with the notches. This joint structure of the protrusions and the notches prevents straight gaps and makes gaps between the buffer component 104 and the adhesive 102 be a curve or a broken line, which further prevents the poor phenomena such as light leakage between the buffer component 104 and the adhesive 102.

In another embodiment of the present disclosure, a difference from the above embodiment is that the buffer component 104 is disposed in the stress buffering sections 10 correspondingly and partially extends to the non-stress buffering sections 20. At this time, the adhesive 102 is correspondingly disposed in the non-stress buffering sections 20 and in contact with the buffer component 104. The setting length of the buffer component 104 is increased, so the buffer effect thereof on the stresses will be improved, thereby further improving the buffer effect of the backlight module on the bending stresses.

In addition, in this embodiment, a side of the buffer component 104 facing away from the interior of the frame housing 101 is provided with protrusions, positions of the adhesive 102 corresponding to the protrusions are provided with notches, and the protrusions are fitted with the notches. This joint structure of the protrusions and the notches prevents the straight gaps and makes the gaps between the buffer component 104 and the adhesive 102 be the curve or the broken line, which further prevents the poor phenomena such as light leakage between the buffer component 104 and the adhesive 102.

It should be noted that a gap shape between the adhesive 102 and the buffer component 104 is not limited to an L shape shown in the figures but may be V-shaped or wavy to make the gaps between the adhesive 102 and the buffer component 104 be the curve or the broken line, which is not limited herein. Further, in the embodiments of the present disclosure, in the first bending positions, the gaps between the adhesive 102 and the buffer component 104 may be defined as the curve or the broken line, while in the second bending positions, the gaps between the adhesive 102 and the buffer component 104 may be defined as a straight line.

In summary, by disposing the buffer component in the bending positions of the frame housing and allowing the buffer component and the adhesive to be disposed staggeredly, the embodiments of the present disclosure allow the backlight module to have the buffer effect on the bending stresses in the bending positions. Therefore, influences of the bending stresses on the backlight module can be reduced during bonding, and the backlight module can have better mechanical and physical performances, thereby preventing poor bonding or loss of effectiveness from occurring. In addition, the embodiments of the present disclosure define contact gaps between the adhesive and the buffer component as the curve or the broken line, which further prevents the backlight module from leaking light, thereby improving the display effect and the product yield.

An embodiment of the present disclosure further provides a display device, which includes the backlight module and a display module attached to the backlight module by the adhesive. The display device can be used in curved liquid crystal displays to reduce the bending stresses suffered by the backlight module in the display device, thereby improving stability and yield of bonding between the backlight module and the display module and improving the display effect.

In the above embodiments, the description of each embodiment has its own emphasis. For the parts that are not described in detail in an embodiment, can refer to the detailed description of other embodiments above.

The backlight module and the display device provided by the present disclosure are described in detail above. The specific examples are applied in the description to explain the principle and implementation of the disclosure. The description of the above embodiments is only for helping to understand the technical solution of the present disclosure and its core ideas, and it is understood that many changes and modifications to the described embodiment can be carried out without departing from the scope and the spirit of the disclosure that is intended to be limited only by the appended claims.

1. A backlight module, comprising:
a frame housing comprising a plurality of stress buffering sections corresponding to bending positions comprising first bending positions and second bending positions, and a plurality of non-stress buffering sections adjacently connected to both ends of the stress buffering sections, wherein the second bending positions are located at corners included in the frame housing and are curve-like in shape;
a backlight element group disposed in an area surrounded by the frame housing;
an adhesive disposed on a top of the frame housing corresponding to at least the non-stress buffering sections and surrounding the frame housing; and
a buffer component disposed on the top of the frame housing corresponding to at least the stress buffering sections located in the second bending positions and being curve-like in shape to correspond to the second bending positions, wherein the buffer component and the adhesive are staggered from each other.

2. The backlight module according to claim 1, wherein a side of the buffer component facing toward an interior of the frame housing is provided with protrusions, positions of the adhesive corresponding to the protrusions are provided with notches, and the protrusions are fitted with the notches.

3. The backlight module according to claim 1, wherein a side of the buffer component facing away from an interior of the frame housing is provided with protrusions, positions of the adhesive corresponding to the protrusions are provided with notches, and the protrusions are fitted with the notches.

4. The backlight module according to claim 1, wherein the buffer component is disposed in the stress buffering sections correspondingly.

5. The backlight module according to claim 1, wherein the buffer component is disposed in the stress buffering sections correspondingly, and a part of the buffer component extends to the non-stress buffering sections.

6. The backlight module according to claim 1, wherein the first bending positions are formed by bending two opposite sides of the frame housing toward a side facing away from the adhesive.

7. The backlight module according to claim 6, wherein the frame housing comprises a plurality of side walls, and the second bending positions are formed by connecting two of the side walls adjacent to each other.

8. The backlight module according to claim 1, wherein the buffer component comprises a single-sided glue, a double-sided glue, or a foam glue material.

9. The backlight module according to claim 1, wherein a thickness of the buffer component ranges from 0.02 mm to 1 mm.

10. A display device, comprising a backlight module and a display module attached to the backlight module by an adhesive;
wherein the backlight module comprises:
a frame housing comprising a plurality of stress buffering sections corresponding to bending positions comprising first bending positions and second bending positions, and a plurality of non-stress buffering sections adjacently connected to both ends of the stress buffering sections, wherein the second bending positions are located at corners included in the frame housing and are curve-like in shape;
a backlight element group disposed in an area surrounded by the frame housing;
the adhesive disposed on a top of the frame housing corresponding to at least the non-stress buffering sections and surrounding the frame housing; and
a buffer component disposed on the top of the frame housing corresponding to at least the stress buffering sections located in the second bending positions and being curve-like in shape to correspond to the second bending positions, wherein the buffer component and the adhesive are staggered from each other.

11. The display device according to claim 10, wherein a side of the buffer component facing toward an interior of the frame housing is provided with protrusions, positions of the adhesive corresponding to the protrusions are provided with notches, and the protrusions are fitted with the notches.

12. The display device according to claim 10, wherein a side of the buffer component facing away from an interior of the frame housing is provided with protrusions, positions of the adhesive corresponding to the protrusions are provided with notches, and the protrusions are fitted with the notches.

13. The display device according to claim 10, wherein the buffer component is disposed in the stress buffering sections correspondingly.

14. The display device according to claim 10, wherein the buffer component is disposed in the stress buffering sections correspondingly, a part of the buffer component extends to the non-stress buffering sections.

15. The display device according to claim 10, wherein the first bending positions are formed by bending two opposite sides of the frame housing toward a side facing away from the adhesive.

16. The display device according to claim 15, wherein the frame housing comprises a plurality of side walls, and the second bending positions are formed by connecting two of the side walls adjacent to each other.

17. The display device according to claim 10, wherein the buffer component comprises a single-sided glue, a double-sided glue, or a foam glue material.

18. The display device according to claim 10, wherein a thickness of the buffer component ranges from 0.02 mm to 1 mm.
